(19) United States
(12) Patent Application Publication
(10) Pub. No.: US 2018/0349565 A1
(43) Pub. Date: Dec. 6, 2018

(54) METHOD OF PRODUCING STANDARD-COMPLIANT APPLICATION DOCUMENT

(71) Applicant: National Yang-Ming University, Taipei City (TW)

(72) Inventors: Ueng-Cheng YANG, Taipei City (TW); Ching-Heng LIN, Taipei City (TW); Yang-Cheng FANN, Taipei City (TW); Hsin-I CHOU, Taipei City (TW); Yin-Chi CHANG, Taipei City (TW)

(21) Appl. No.: 15/826,111

(22) Filed: Nov. 29, 2017

(30) Foreign Application Priority Data
Jun. 6, 2017 (TW) 106118744

(51) Int. Cl. G06F 19/00

(52) U.S. Cl. CPC G06F 19/363; G06F 17/2725

(57) ABSTRACT

This invention provides a method for producing standard-compliant application document, in which the steps comprise: inputting a plural of validation rules and guidelines into a rule validation engine. Then, using this engine to validate a plural of fields entered in a study protocol design system, and outputting the study protocol. Further to upload the study protocol to an institutional review board (IRB) review system and/or a statistical review system, and outputting an approved study protocol. The protocol information of this approved protocol can be used by the clinical trial management system to carry out the data collection process. The data collected by this approved study protocol are converted to a standard-compliant document by a data tabulation system. Finally, the test results are validated by the rule validation engine to generate a standard-compliant application document.

### CROSS-REFERENCE TO RELATED APPLICATIONS

This Non-provisional application claims priority under 35 U.S.C. § 119(a) on Patent Application No(s). TW106118744 filed in Taiwan, Republic of China Jun. 6, 2017, the entire contents of which are hereby incorporated by reference.

### FIELD OF THE INVENTION

The present invention relates to a method for producing standard-compliant application document, and more particularly, to a method for producing a submission document conforming to a new medicine or a medical material application.

### BACKGROUND OF THE INVENTION

With clinical research gradually towards electronic, which is called eClinical trial, the using of the Clinical Data Management System (CDMS) becomes more popular. Like the hospital information system (HIS), the clinical trial management system does not refer to a single system, but contains all relevant information systems involved in the clinical trials, such as electronic data capture system, study subject management system and regulatory data tabulation system, etc. In a broader definition, the trial application and management system of Institutional Review Board (IRB) can also be incorporated into the implementation process. The standardization of electronic clinical trial data will become the future development trend, which can ensure the quality of test data and accelerate the process of data integration analysis.

The Clinical Data Interchange Standards Consortium (CDISC) is an international standards development organization. Its main task is to establish a series of clinical research data collection, exchange, submission and archiving standards, including such as Clinical Data Acquisition Standards Harmonization, (CDASH), Study Data Tabulation Model (SDTM), the Standard for Exchange of Nonclinical Data (SEND), and the Analytical Data Model (ADM), which covering the entire clinical trial process.

For an example, in the drug permit license application, it will require applicant to fill the necessary information in a standard form. However, most of applicants may neglect parts of detailed data; It will not only take a lot of time and manpower to repeat supplement experiment, but is also possible to find some incomplete information needed for the regulatory review. For the companies, each time extension may generate additional costs and reduce revenue. Therefore, why we do not consider an experiment according to the standard at the beginning of the trial, meaning the stage of “design”, and an information system can be introduced to lead the researchers in collecting structured information that would avoid missing data, so as to increase the administrative efficiency.

CDISC has developed the Protocol Representation Model (PRM) for clinical trial design and planning, which is refers to the Good Clinical Practice (GCP) guideline, to suggest project content that should be included in the study plan. In addition to standardizing the contents of the study protocol, the file format for the study protocol is also regulated. With the practice of consistency, it is possible to increase the interoperability of the study protocol, so as to achieve the purpose and convenience of the secondary use of the data.

After completing a study protocol, the Institutional Review Board (IRB) will review whether the test design conform ethical, and the statistical examination will confirm the test assessment and the appropriateness according to ethics and statistics regulation.

End of the above reexaminations, the investigators had to execute clinical trials and to collect information from subjects. In the implementation of clinical trials, GCP needs to be followed during the trial. In addition to constantly check the information content is correct, but also to report the test bias and serious adverse events. Auditing and inspection is also needed to ensure the compliance with the provisions of the implementation plan. When the clinical trial is completed, if the drug is intended to be listed, the study protocol and the clinical data of the subject, etc., shall be submitted to the regulatory authority electronically in standard format.

The above states show that the data of a study protocol is constantly used in each stage of the trial. However, the current study protocol belongs a text file, and many of the research information may be scattered throughout the narrative of different paragraphs, it is difficult to be checked by a common system, such as verifying the completeness of the required information. If any information being lost or is incorrect, the drug permit license application will be required to continually supplement the information, and the experimental data is also needed to be complied with regulations.

### SUMMARY OF THE INVENTION

Accordingly, the present invention has been used to informative and systematize the workflow of experienced large clinical trial companies through information technology, so as to reduce the burden of designing new trials. The object of the present invention can be used to design the steps of experimental and provide a standardize application form according to the international standard regulation through the system, further to establish the inspection mechanism for forming a complete process.

The present invention provides a method for producing a standard-compliant application document, which comprises:

(a) inputting a plural of standard specifications into a rule validation engine to establish a plural of validation rules, wherein the standard specification is plain text document;

(b) designing a plural of fields through a study protocol design system based on the validation rules, and submitting the plural of filled fields to the rule validation engine to check whether they meet the validation rules; the step (c) is carried out if the plural of fields meet the validation rules, and the study protocol design system would show an error field if the plural of fields do not meet the validation rules;

(c) outputting a study protocol from the study protocol design system;

(d) submitting the study protocol by an institutional review board (IRB) review system or a statistical review system to verify whether the study protocol meets an ethics and statistics regulation; the step (e) is carried out if the study protocol meets the ethics regulation and statistics methodology, and the study protocol design system would show a rejection if the study protocol do not meet the ethics regulation and statistics methodology;

(e) outputting an approved study protocol from the IRB review system or the statistical review system, and transmitting the approved study protocol into a data tabulation system and a clinical trial management system for collecting a plural of test results in different stages; and

(f) submitting the plural of test results collected from the clinical trial management system to the data tabulation system, and the rule validation engine will verify whether the test results meet the validation rules; the data tabulation system would output the standard-compliant application document if the test results meet the validation rules, otherwise the data tabulation system would show the error fields of the collected test results if the test results do not meet the validation rules.

The present invention can be applied to the clinical trial design and management system, the information system of the contract research organization (CRO), etc., which can support designing the clinical trial protocols under the regulation of Good Clinical Practice (GCP).

### BRIEF DESCRIPTION OF THE DRAWINGS

FIG. 1 shows the method for producing a standard-compliant application document of the present invention.

FIG. 2 shows the diagram of detail process in the rule validation engine.

FIG. 3 shows the diagram of detail process in the study protocol design system.

FIG. 4 shows one embodiment of the data field of the present invention.

FIG. 5 shows one embodiment of the design instruction of the present invention.

FIGS. 6A and 6B show the study protocol of the present invention in a conformant format.

### SYMBOLS

S101-s118 the steps of producing the standard-compliant application document
11 standard specification
12 rule validation engine
13 study protocol design system
14 study protocol
15 IRB review system
16 statistical review system
17 approved study protocol
18 clinical trial management system
19 data tabulation system
20 rule validation engine
201 validation rule
203 rule classifier
205 inference engine
21 trial design data
22 messages
30 clinical trial design system
31 standard specification
32 design interface
321 standard-based data fields
323 design instructions
33 study protocol database
34 standard format output
40 study protocol
501 external link index
503 user instructions

### DETAILED DESCRIPTION OF THE INVENTION

For clarity of disclosure, and not by way of limitation, the detailed description of the invention is divided into the subsections that follow. The present invention provides merely an example of the different types of functional arrangements that may be employed to implement the operation in the various components of a system, such as a computer connected to a detector, a multiprocessor computing device, and so forth.

The method execution steps of the present invention may include application specific software which may store in any portion or component of the memory including, such as random access memory (RAM), read-only memory (ROM), hard drive, solid-state drive, magneto optical (MO), IC chip, USB flash drive, memory card, optical disc such as compact disc (CD) or digital versatile disc (DVD), floppy disk, magnetic tape, or other memory components.

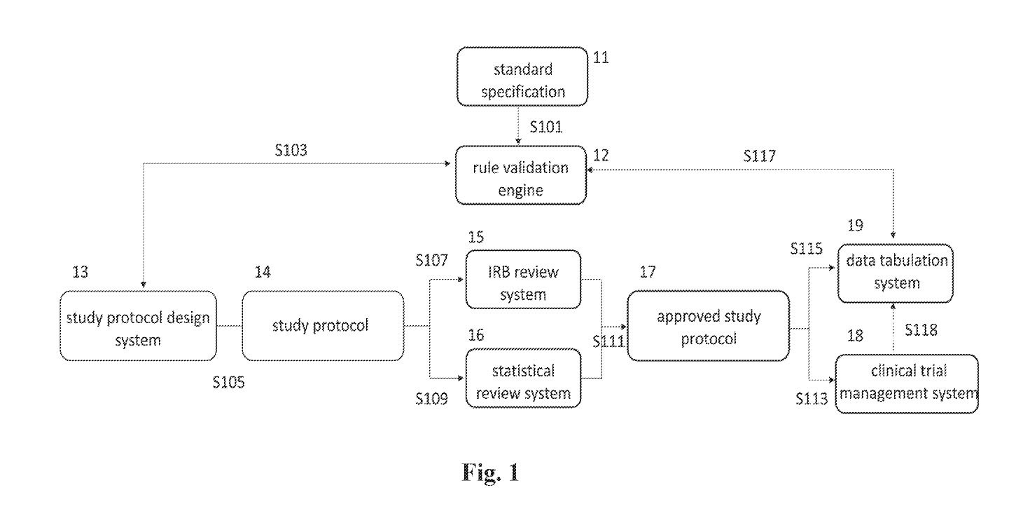

Please refer to FIG. 1, which shows the method for producing a standard-compliant application document of the present invention, which comprises: inputting a plural of standard specifications 11 into a rule validation engine 12 to establish a plural of validation rules in step S101, wherein the standard specification 11 is a plain text document and is including all kinds of the clinical trials related international regulations, which can be, but not limited to, CSISC standard, requirements from cliniacltrials.gov, ICH GCP E6 protocol writing principles and/or FDA validation specifications etc.

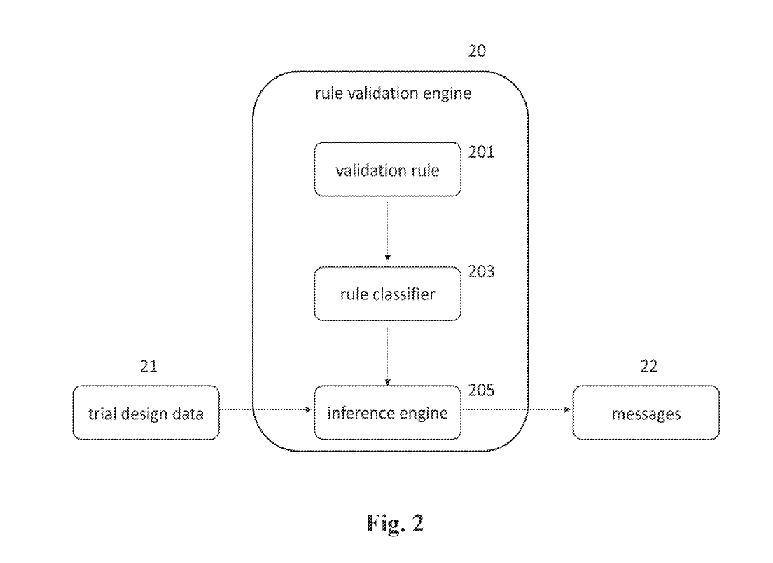

Please refer to FIG. 2, which is the diagram of detail process of the rule validation engine 20. The rule validation engine 20 includes a plural of validation rules 201, a rule classifier 203 and an inference engine 205, which is used for verifying by the rules of the standard specification 11 to check whether the information filled in the field is correct. A reminder message 22 would be generated if there is missing or logic error in the trial design data 21.

Wherein the validation rules 201 is designed by at least one of a standard; in one of the embodiment, the standard is including all kinds of the clinical trials related international regulations, which can be, but not limited to, CSISC standard, requirement from cliniacltrials.gov, ICH GCP E6 protocol writing principles and/or FDA validation specifications etc. The rule classifier 203 classifies the validation rules according to the information required for the various stages, further to validate and examine a document information with the inference engine 205.

In step S103, a plurality of fields is provided by the study protocol design system 30 based on the validation rules 201, and the filled fields will be submitted to the rule validation engine 12 to check whether they meet the validation rules.

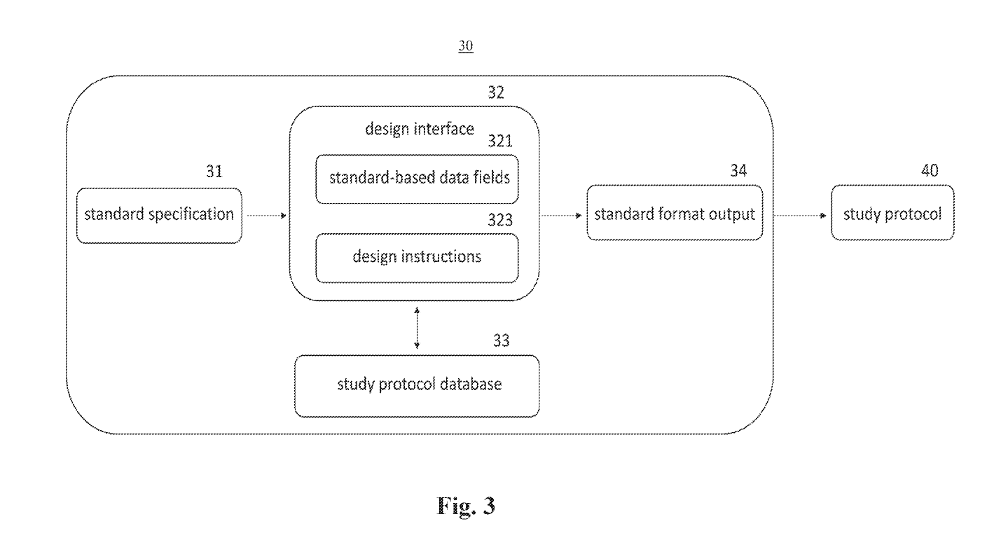

Please refer to FIG. 3, which is the diagram of detail produce of the study protocol design system 30. Wherein the study protocol design system includes a design interface 32 and a study protocol database 34, which outputs the study protocols 31 in a standard format 34. Preferably, the standard format 34 is selected from the group of operational data model (ODM), study design model (SDM) and other international common models to finish the design of study protocol 40. Wherein the design interface 32 includes a standard-based data field 321 and a design instruction 323, and the design instructions 323 is used for describing the standard-based data field. The design interface 32 is designed by at least one of standards; in one of the embodiment, the standard is including all kinds of the clinical trials related international regulations, which can be, but not limited to, CDISC standard, requirement from cliniacltrials.gov, ICH GCP E6 protocol writing principles and/or FDA validation specifications etc.

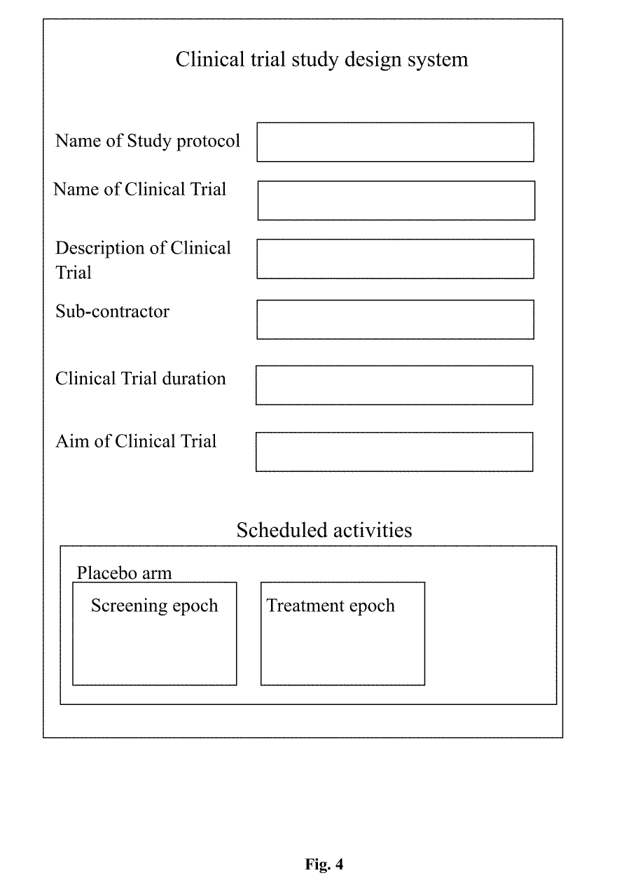

Please refer to FIG. 4, which is one embodiment of the provided field of the present invention, the fields can be used to record the study plan information. Then, the rule validation engine 12 can validate whether the filled fields meet the designed validation rules; the study protocol design system 13 will proceed to step S105 if the filled information meet the designed validation rules, otherwise it would show the error fields if the filled information do not meet the designed validation rules, then the user can modify the data under the instructions.

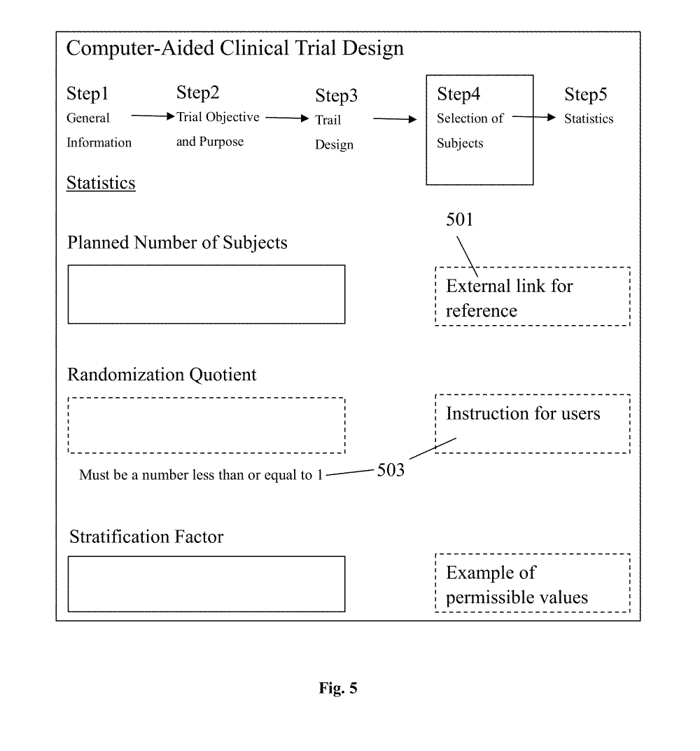

Please refer to FIG. 5, which is one embodiment of the design instruction of the present invention, the clinical trial design system provides different design instructions, which comprises external link index 501, user instructions 503 and allowed value examples. Then the user can fill the fields according to the annotations.

In step S105, the study protocol design system 13 outputs study protocol 14 after be completed filling. During this step, the study protocol 14 is designed under the Operational Data Model (ODM)/Study Trial Modulation (SDM) format of CDISC standard, and its contents should contain at least one protocol data, an experimental design, a schedule of activities and a case report form.

In one embodiment of the present invention, the content of the protocol information includes the purpose of the trial, the eligibility criteria of the subject, the intended test effect, the possible injury and the manner of treatment, etc. Besides, the experimental design includes the number of subjects, the grouping method, the randomization method, the experimental intervention design, etc. Wherein the schedule of activities includes schedule of the subject to be tested, measured, interviewed, tracked and other test evaluated in the program etc. In addition, the case report form includes the test data of subjects, basic demographic data, past medical history, may also include, but not limited to, questionnaires, scales, vital signs, or laboratory tests.

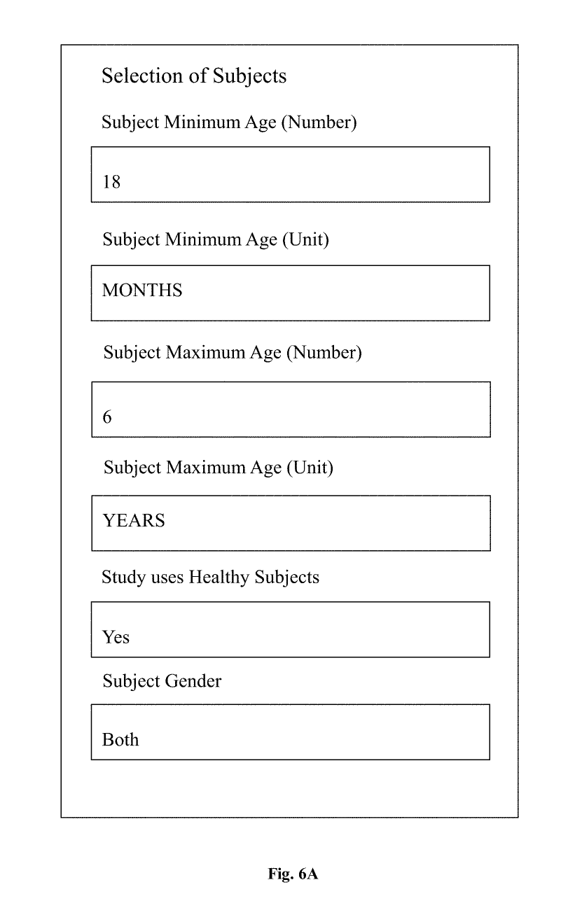

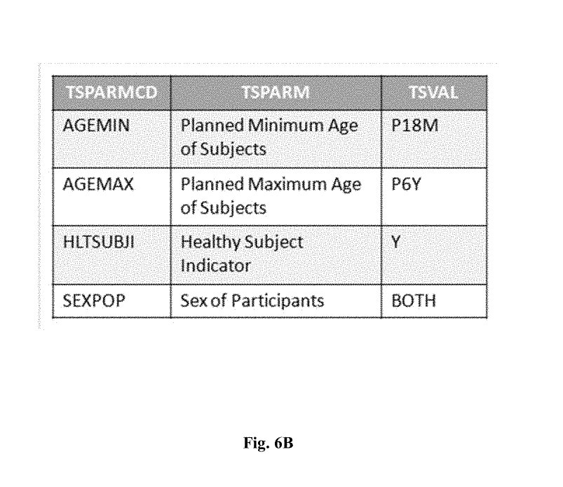

According to FIGS. 6A and 6B, which shows the study protocol of the present invention in a conformant format, in which the minimum age of the subject is 18 months old and the maximum age is 6 years old, and the tests include healthy and different genders. In the standard format, they are represented as “P18M”, “P6Y”, “Y” and “BOTH” respectively.

Furthermore, in steps S107 and S109, the study protocol 14 is submitted to an IRB review system 15 or a statistical review system 16 to validate whether the study protocol 14 meet the ethics and statistics regulation. Then, the step S111 is performed if the study protocol 14 is allowed; otherwise, the rejection with reasons is showed if the study protocol 14 does not meet the ethics and statistics regulation. The study protocol 14 can be revised and modified for several times according to the review result until there is no error in the study protocol. In step S111, after completion of the review, the study protocol design system 13 will generate the approved study protocol 17.

Preferably, the approved study protocol 17 is imported into a clinical trial management system 18 in step S113. The test subjects should follow the design of approved study protocol 17 and set up the schedule. It does not only remind stages should be done, but also assist the user to collect the experiment data.

In step S115, the approved study protocol 17 is also imported to the data tabulation system 19. After completing the experiment, the test result would be export from the clinical trial management system 18 to the data tabulation system 19 in step S118. Then, the data tabulation system 19 is further to develop the collected data into the electronic case report form (eCRF) according to the approved study protocol 17.

Furthermore, in step S117, whenever the user has filled in the test result of each time period, the rule validation engine will verify the plural of test results whether meet the validation rules. The data tabulation system 19 would output the electronic case report form (eCRF), which includes the study protocol, the trial data, the CRF and the analysis result, if the test results meet the validation rule; otherwise, the data tabulation system 19 would show the error fields of the collected test results if the test results do not meet the validation rule. Therefore, the eCRF may follow the requirement of relation license application, such as drug permit license or permit for manufacturing etc,

The previous protocol design system requires the user to transform the clinical trial data into a standard-compliant document in accordance with the experience, and each time the different protocols are to be redesigned. The present invention designs a set of writing process based on the international clinical research organization specifications, and the text of the CDISC guidelines is built in the fields of the form, as an example prompted to help the protocol to be met the standard. In addition, the present invention facilitates the user to establish the rules to be checked by the users themselves, and to introduce the FDA guidance, to classify the rules according to the different stages, to establish the rules to be checked, to check at different stages so as to achieve immediate inspection, so as to reduce the probability of errors.

The electronic clinical trial protocol designed by the present invention can be imported into an electronic IRB review system, to review the process of experiment whether is based on ethics and statistics regulation by an independent organization, and may be further linked to a clinical trial electronic data acquisition (EDC) system. (Such as the number of subjects, assignments, visits, etc.) The collection and management of the clinical data of the subjects is carried out in the EDC system.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A method for producing a standard-compliant application document, which comprises:
(a) inputting a plural of standard specifications into a rule validation engine to establish a plural of validation rules, wherein the standard specification is a plain text document;
(b) designing a plural of fields from a study protocol design system based on the validation rules, and submitting the plural of fields to the rule validation engine to check whether they meet the validation rules, and the step (c) is carried out if the plural of fields meet the validation rules, otherwise the study protocol design system would show an error field if the plural of fields do not meet the validation rules;
(c) outputting a study protocol from the study protocol design system;
(d) submitting the study protocol to an institutional review board (IRB) review system or a statistical review system to verify whether the study protocol meets an ethics and statistics regulation, and the step (e) is carried out if the study protocol meets the ethics regulation and statistics methodology, otherwise the study protocol design system would show the error field if the study protocol do not meet the ethics regulation and statistics methodology;
(e) outputting an approved study protocol from the ethics review system or the statistical review system, and transmitting the approved study protocol into a data tabulation system and a clinical trial management system for collecting a plural of test results in different stages; and
(f) submitting the plural of test results, that collected from the clinical trial management system, to the data tabulation system, and the rule validation engine will verify whether the test results meet the validation rules, and the data tabulation system would output the standard-compliant application document if the test results meet the validation rules, otherwise the data tabulation system would show the error field of the collected test results if the test results do not meet the validation rules.

2. The method for producing a standard-compliant application document of claim 1, wherein the study protocol design system includes a design interface and a study protocol database, which outputs the study protocols in a standard format.

3. The method for producing a standard-compliant application document of claim 1, wherein the design interface includes a standard-based data field and a design instruction, and the design instructions is used for describing the standard-based data field.

4. The method for producing a standard-compliant application document of claim 1, wherein the standard format is selected from the group of operational data model (ODM), study design model (SDM) and other international common models.

5. The method for producing a standard-compliant application document of claim 2, wherein the study protocols includes at least a protocol information, an experimental design, a schedule of activities and a case report form.

6. The method for producing a standard-compliant application document of claim 1, wherein the rule validation engine includes a validation rule, a rule classifier, and an inference engine.

7. The method for producing a standard-compliant application document of claim 6, wherein the required fields are classified according to the validation rule.

8. The method for producing a standard-compliant application document of claim 7, wherein the inference engine validates and examines the trial design data, and the reminder message would be generated if there is missing or logic error of the trial design data.
